(19) United States
(12) Patent Application Publication
(10) Pub. No.: US 2010/0308011 A1
(43) Pub. Date: Dec. 9, 2010

(54) METHOD OF MANUFACTURING MAGNETIC RECORDING MEDIUM

(75) Inventors: Gohei Kurokawa, Ichihara-shi (JP); Satoru Nakajima, Ichihara-shi (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Minato-ku, Tokyo (JP)

(21) Appl. No.: 12/740,643

(22) PCT Filed: Oct. 17, 2008
(86) PCT No.: PCT/JP2008/069291

§ 371 Date: Jun. 22, 2010

(30) Foreign Application Priority Data
Oct. 30, 2007 (JP) 2007-281751

(51) Int. Cl. B05D 5/12

(52) U.S. Cl. 216/22

(57) ABSTRACT

A step of subjecting a carbon film deposited and adhering onto a surface of the carrier to an ashing removal in oxygen-including gas is executed after a step of detaching a magnetic recording medium after film formation from the carrier and before a step of attaching a next film-formation substrate to the carrier, and a pulsed voltage bias is applied to the carrier when executing the step of subjecting the carbon film to the ashing removal. Further, at an initial stage of the step of subjecting the carbon film to the ashing removal, a concentration of inactive gas in the plasma is increased as compared with an oxygen gas concentration and the oxygen gas concentration is then increased as compared with the concentration of the inactive gas. As a result, the carbon film deposited on the substrate-holding carrier is effectively reduced, generation of particles to follow peeling off the deposited film is suppressed, and emission of outgas originating from the carbon film deposited on the surface of the carrier is suppressed.

### TECHNICAL FIELD

The present invention relates to a method of manufacturing a magnetic recording medium used in a hard disk device or the like. More specifically, the present invention relates to a method of manufacturing a magnetic recording medium capable of removing a carbon film deposited on a surface of a substrate-holding carrier by asking treatment and reducing generation of dust and gas within the device.

### BACKGROUND ART

In recent years, recording density has considerably increased in the field of magnetic recording mediums and among others, magnetic disks. Recently the recording density has particularly continuously increased at tremendous rate to about 100 times as high as that of ten years before. Diversified technologies back up such an increase in the recording medium. One of the key technologies is a technology for controlling sliding characteristics between a magnetic head and a magnetic recording medium.

Since CSS (contact start/stop) system called Winchester Style in which basic operation between a magnetic head and a magnetic recording medium is defined as contact slide, head float, and contact slide have become mainstream of hard disk drives, there is no avoiding sliding of a head on the recording medium. Tribology-related problems between the magnetic head and the magnetic recording medium are fatal technical problems up to the present. Due to this, abrasion resistance and sliding resistance of a medium surface serve as significant gist of reliability of a magnetic recording medium, and a protection film, a lubricating film and the like stacked on a magnetic film have been continuously developed and improved with this aim.

Protection films made of various materials have been proposed as the protection film of the magnetic recording medium. From general viewpoints of film formation, durability and the like, a carbon film is mainly employed as the protection film of the magnetic recording medium. The carbon film is conventionally formed by CVD method. Since film formation conditions for the carbon film directly affect corrosion resistance or CSS characteristics of the carbon film, the conditions are very important.

Further, to improve recording density, it is preferable to make reduction in a flying height of the magnetic head, an increase in the number of revolutions of the medium and the like. Accordingly, higher sliding durability is required for the magnetic recording medium.

On the other hand, to reduce spacing loss and to improve the recording density, it has been required to make a thickness of the protection film as thin as possible to, for example, a film thickness equal to or smaller than 100 angstroms (Å). Due to this, the protection film having not only smoothness but also thinness and rigidity is strongly desired.

Nevertheless, if the thickness of the carbon protection film formed by the conventional sputtering film formation method is set to, for example, be equal to or smaller than 100 Å, the carbon protection film often has insufficient durability.

In these circumstances, a method using plasma CVD method has become mainstream of the method of forming a carbon protection film since a carbon protection film formed by the plasma CVD method is higher in strength than that formed by the sputtering method.

However, with the method of forming the carbon protection film using the sputtering or the plasma CVD method, carbon is deposited not only on a surface of a substrate but also on a surface of a substrate-holding carrier and the like in a film formation device. If a deposition amount of the carbon increases on an exposed surface, a film made of deposited carbon is peeled off from the exposed surface by internal stress or the like. If carbon particles generated by such peeling adhere onto the surface of the substrate, protrusions are formed on a surface of the carbon protection film and locally film thickness failure occurs, disadvantageously resulting in product failure. Particularly if the carbon protection film is formed by the plasma CVD method, the film made of carbon is higher in hardness and higher in the internal stress of the film than carbon protection film formed by the conventional sputtering method. As a result, more carbon particles are generated and the above-stated film thickness failure and the like disadvantageously occur.

To prevent generation of the particles stated above, there is proposed a method of performing asking removal on the carbon film deposited on the surface of the substrate-holding carrier by using oxygen plasma (see, for example, Japanese Patent Application Laid-Open Nos. 11-229150 and 2002-025047). Furthermore, to prevent the film deposited on the surface of the substrate-holding carrier from being peeled off, a treatment for suppressing peeling off deposits on electrodes by roughening the surface of the carrier is performed (see, for example, Japanese Patent Application Laid-Open No. 2006-173343).

However, recently it has been desired to further improve cleanliness of the surface of the magnetic recording medium so as to further improve the recording density of the magnetic recording medium. With only the above-stated procedure, portions of the carrier on which plasma tends to concentrate such as ends of the carrier are positively subjected to ashing whereas portions of the carrier on which less plasma tends to concentrate such as flat portions thereof are insufficiently subjected to ashing. This results in circumstances in which generation of particles cannot be reduced and it is difficult to reduce defects deriving from the particles of the carbon protection film on the magnetic recording film.

As stated above, one of causes for generating particles deriving from the carbon protection film is difficulty to improve the cleanliness of the substrate-holding carrier itself. A method for improvements has been desired.

Moreover, according to study of the inventors of the present invention, the carbon film deposited on the surface of the carrier cannot be completely removed mainly in the flat portions of the carrier even after the ashing treatment and remains as residue. It is confirmed that this residue is emitted as outgas in a vacuum chamber after being transported, along with the carrier, to another film formation chamber. In order to realize further improvement in the recording density of the magnetic recording medium and obtaining of stable quality, it is necessary to avoid emission of components other than intentionally used process gas in the vacuum chamber. It is, therefore, also desired to improve such emission.

The present invention has been made in light of the above-stated problems. It is an object of the present invention to provide a manufacturing method capable of manufacturing a magnetic recording medium high in recording density, excellent in recording and reproducing characteristics, and stable in quality by effectively reducing a carbon film deposited on a substrate-holding carrier, suppressing generation of particles to follow peeling off the deposited film, and also suppressing emission of outgas originating from the carbon film deposited on a surface of the carrier when the carbon protection film is formed on a substrate by a CVD method or the like.

### DISCLOSURE OF THE INVENTION

The inventors of the present invention made utmost efforts and studies to solve the problems. As a result, it is discovered that the remaining carbon film deposited on the substrate-holding carrier when forming the carbon protection film on the substrate can be efficiently removed by providing an ashing step using oxygen plasma under condition of applying a bias voltage to the carrier after a step of detaching a magnetic recording medium after film formation from the carrier and before a step of attaching the film-formation substrate to the carrier. And also, it is discovered that ashing efficiency is greatly improved by applying a magnetic field to the oxygen plasma to generate convergence of the plasma, particularly improved by forming a magnetic field near a region of the carrier on which more carbon is particularly deposited. Namely, the present invention relates to the following respects.

(1) A method of manufacturing a magnetic recording medium characterizing in that including steps of sequentially transporting a film-formation substrate attached to a carrier into a plurality of chambers connected to one another; and forming at least a magnetic film and a carbon protection film on the film-formation substrate, wherein the method having a step of subjecting the carbon film deposited and adhering onto a surface of the carrier to an ashing treatment in oxygen-containing plasma generated in a chamber after a step of detaching the magnetic recording medium after film formation from the carrier and before a step of attaching a next film-formation substrate to the carrier, and wherein a bias voltage is applied to the carrier when executing the step of subjecting the carbon film to the ashing treatment.
(2) The method of manufacturing the magnetic recording medium according to (1), characterizing in that the bias voltage is a pulsed voltage bias.
(3) The method of manufacturing the magnetic recording medium according to (1) or (2), characterizing in that wherein inactive gas is further added to the plasma.
(4) The method of manufacturing the magnetic recording medium according to (3), characterizing in that at an initial stage of the step of subjecting the carbon film to the ashing treatment, a concentration of the inactive gas in the plasma is increased as compared with an oxygen gas concentration and the oxygen gas concentration is then increased as compared with the concentration of the inactive gas.
(5) The method of manufacturing the magnetic recording medium according to (4), characterizing in that after the oxygen gas concentration is increased as compared with the concentration of the inactive gas, the concentration of the inactive gas is increased again as compared with the oxygen gas concentration.
(6) The method of manufacturing the magnetic recording medium according to any one of (1) to (5), characterizing in that a magnetic field is applied to the oxygen-containing plasma from an outside to concentrate the plasma acting on the ashing treatment on the surface of the carrier.
(7) The method of manufacturing the magnetic recording medium according to (6), characterizing in that wherein the magnetic field applied to the plasma is a magnetic field generated by a permanent magnet.

With the method of manufacturing the magnetic recording medium by using the method of subjecting the carbon film deposited on the substrate-holding carrier to ashing treatment according to the present invention, it is possible to suppress the carbon film from being peeled off from the carrier to generate particles and suppress the particles from adhering to the substrate itself. It is also possible to suppress outgas from the carrier.

### BRIEF DESCRIPTION OF THE DRAWINGS

FIG. 1 is a schematic longitudinal sectional view showing an example of a magnetic recording medium manufactured by a method of manufacturing a magnetic recording medium according to the present invention;

FIG. 2 is a pattern diagram showing a magnetic recording medium manufacturing device according to the present invention;

FIG. 3 is a pattern diagram showing a sputtering chamber and carriers which the magnetic recording medium manufacturing device according to the present invention comprises;

FIG. 4 is a side view showing the carrier which the magnetic recording medium manufacturing device according to the present invention comprises; and

FIG. 5 is a pattern diagram showing an asking treatment device according to the present invention.

### BEST MODE FOR CARRYING OUT THE INVENTION

Ashing treatment performed on a carbon film deposited on a carrier according to the present invention will be described hereinafter.

First, a magnetic recording medium that is an example of a thin film stacked body manufactured by a method of manufacturing a magnetic recording medium according to the present invention will be described.

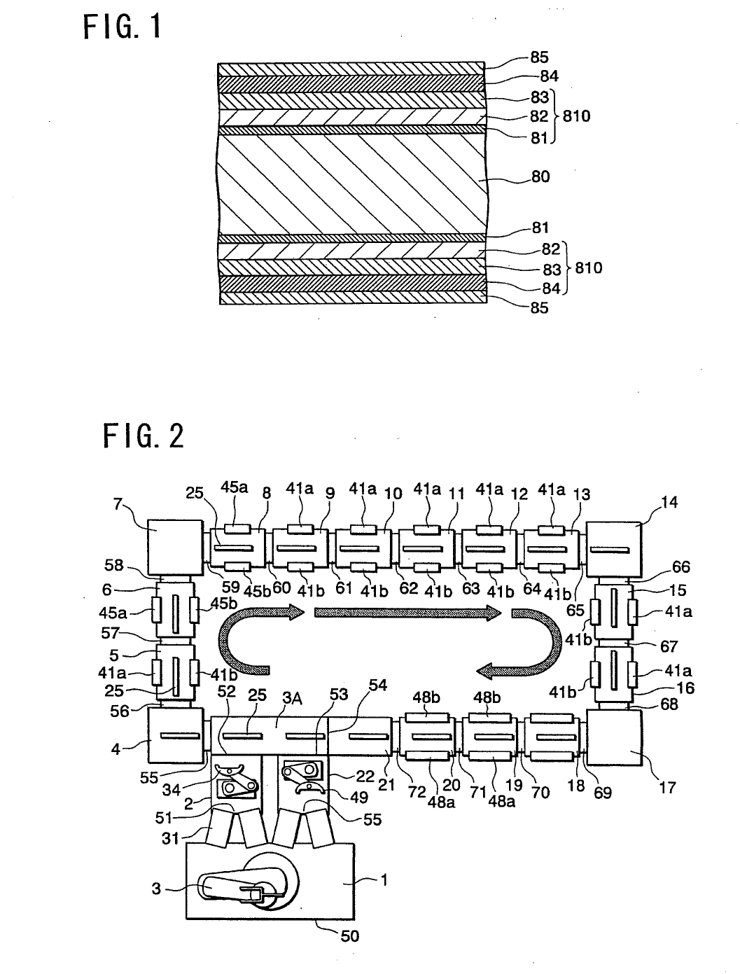

FIG. 1 is a schematic longitudinal sectional view showing an example of the magnetic recording medium (thin film stacked body) manufactured by the manufacturing method according to the present invention.

As shown in FIG. 1, this magnetic recording medium is configured to include, for example, a nonmagnetic substrate 80, and a seed layer 81, a base film 82, a magnetic recording film 83, a protection film 84, and a lubricant layer 85 sequentially stacked on each of or one of both surfaces of the nonmagnetic substrate 80.

As the nonmagnetic substrate 80, a generally used Al alloy substrate having a NiP plated film formed thereon (hereinafter, “NiP-plated Al substrate”) and others, a glass substrate, a ceramics substrate, a flexible resin substrate or a substrate obtained by coating one of these nonmagnetic substrates with NiP by plating or sputtering method can be used.

The nonmagnetic substrate 80 may be subjected to texture treatment for such a purpose as to obtain better electromagnetic conversion characteristics, to improve heat fluctuation characteristics by adding in-plane magnetic anisotropy or to eliminate polishing trace or the like.

The seed layer (lower base layer) 81 formed on the nonmagnetic substrate 80 controls crystalline orientation of a film present right on the seed layer 81. As a constituent material of this seed layer 81, for example, Ti, TiCr, Hf, Pt, Pd, NiFe, NiFeMo, NiFeCr, NiAl, NiTa, and NiNb can be appropriately used according to the film present right on the seed layer 81.

Furthermore, the seed layer 81 may have a multilayer structure in which a plurality of films equal in composition or different in composition is stacked as needed besides single-layer structure.

As the base film 82, a conventionally known nonmagnetic base film for example a single composition film of Cr, Ti, Si, Ta or W or the like, or an alloy film containing other elements in a range in which crystallinity of each of these elements is not degraded can be used. However, because of the after-mentioned relation between the base film 82 and the magnetic recording film 83, it is desired that the base film 82 contains Cr as a single composition or that the base film 82 is made of alloy containing Cr and one or two or more types of elements from among Mo, W, V, and Ti. Depending on a type of the nonmagnetic substrate 80, in particular, it is preferable to stack NiAl as the base film 82 since SNR is considerably improved.

A thickness of the base film 82 is not limited to a specific one as long as the base film 82 can obtain desired coercivity but is preferably in a range of 5 nm to 40 nm and more preferably in a range of 10 nm to 30 nm. If the base film thickness 82 is too thin, crystalline orientation of the magnetic recording film 83 on the base film 82 or a nonmagnetic intermediate film provided between the base film 82 and the magnetic recording film 83 on an as-needed basis is deteriorated and the SNR is reduced. Therefore, it is unpreferable to set the film thickness of the base film 82 to be excessively small. Conversely, if the base film 82 is too thick, then a particle diameter of particles in the base film 82 increases and that of particles in the magnetic recording film 83 on the base film 82 or the nonmagnetic intermediate film increases according to an increase in the particle diameter of particles in the base film 82, and the SNR is reduced. Therefore, it is unpreferable to set the film thickness of the base film 82 to be excessively large.

Furthermore, the base film 82 may have a multilayer structure in which a plurality of films equal in composition or different in composition is stacked as needed besides single-layer structure.

The magnetic recording film 83 is not limited to a specific magnetic film as long as the magnetic film can obtain desired coercivity. However, if the magnetic recording film 83 is a Co alloy layer represented by CoₐCr_{b}Pt_{c}Ta_{d}ZrₑCu_{f}Ni_{g} (where a, b, c, d, e, f, and g denote composition ratios and b: 16 to 25 atom %, c: 0 to 10 atom %, d: 1 to 7 atom %, e: 0 to 4 atom %, f: 0 to 3 atom %, g: 0 to 10 atom %, and a: remainder thereof), it is possible to improve the magnetic anisotropy and further improve the coercivity.

In the magnetic recording medium according to the present embodiment, the protection film 84 is formed on the magnetic recording film 83 to prevent damage caused by contact between a head and a surface of the medium. As a matter constituting the protection film 84, a conventionally known matter can be used. For example, a film containing a single component such as C, SiO₂ or ZrO₂ or a film containing those components as main components with an additive element contained therein can be used as the protection film 84.

The protection film 84 can be formed by the sputtering method, an ion beam method, the plasma CVD method or the like.

A thickness of the protection film 84 is normally 2 nm to 20 nm. The thickness of the protection film 84 is preferably 2 nm to 9 nm since spacing loss can be reduced.

The lubricant layer 85 is formed on a surface of the protection film 84. As lubricant, fluoride liquid lubricant such as perfluoropolyether (PFPE) or solid lubricant such as fatty acid is used. As a method of coating the lubricant, a conventionally known method such as a dipping method or a spin coating method may be used.

Next, a method of manufacturing the magnetic recording medium that is one example of the thin film stacked body according to the present invention will be described.

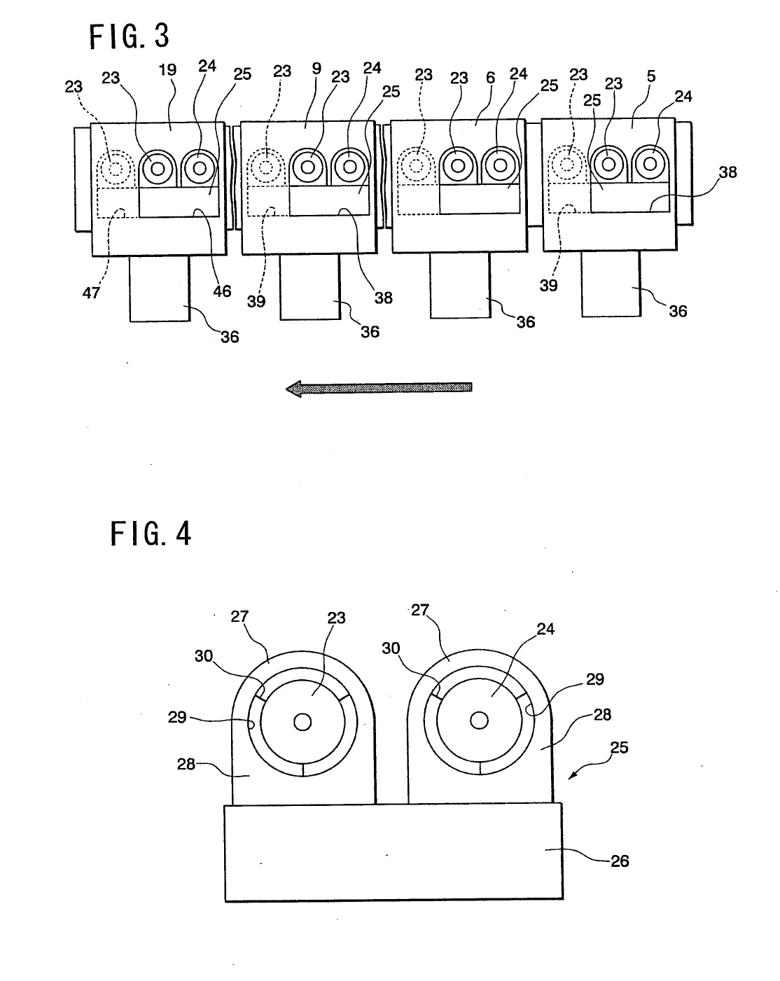

FIG. 2 is a pattern diagram showing an example of a magnetic recording medium manufacturing device according to the present invention. FIG. 3 is a pattern diagram showing a sputtering chamber and carriers of the magnetic recording medium manufacturing device according to the present invention. FIG. 4 is a side view showing the carrier included in the magnetic recording medium manufacturing device according to the present invention. In FIG. 3, a carrier indicated by a solid line shows a state of stopping at a first film formation position, and a carrier indicated by a broken line shows a state of stopping at a second film formation position. Namely, the sputtering chamber shown in this example includes two targets facing a substrate therein. Therefore, a film is formed on the substrate at the left side of the carrier in the state in which the carrier stops at the first film formation position. Thereafter, the carrier moves to the position indicated by the broken line and a film is formed on the substrate at the right side of the carrier in the state in which the carrier stops at the second film formation position. If four targets are present to face the substrate within the chamber, then there is no need to move the carrier as stated above, and films can be formed simultaneously on the substrates held at the right side and the left side of the carrier.

As shown in FIG. 2, this magnetic recording medium manufacturing device having a substrate cassette transfer robot base 1, a substrate cassette transfer robot 3, a substrate supply robot chamber 2, a substrate supply robot 34, a substrate attachment chamber 52, corner chambers 4, 7, 14, and 17 for rotating each carrier, sputtering chambers and substrate heating chambers 5, 6, 8 to 13, 15, and 16, protection film formation chambers 18 to 20, a substrate detachment chamber 54, substrate detachment robot chambers 22 and 53, a substrate detachment robot 49, a carrier asking chamber 3A, and a plurality of carriers 25 to which a plurality of film-formation substrates (nonmagnetic substrates) 23 and 24 is attached.

Vacuum pumps are connected to these chambers 2, 52, 4 to 20, 54, and 3A, respectively. The carrier 25 is sequentially transported into the chambers each turned into a reduced pressure state by operations of these vacuum pumps. In each formation chamber is constituted as thin films (for example, the seed layer 81, the base layer 82, the magnetic recording film 83, and the protection film 84) are formed on both surfaces of the attached film-formation substrates 23 and 24, thereby obtaining the magnetic recording medium as an example of the thin film stacked body.

For example, the magnetic recording medium manufacturing device configured as stated above is constituted as an inline film formation device. It is to be noted that the magnetic recording medium manufacturing device configured as stated above can form the seed layer 81, the base layer 82, the magnetic recording film 83, and the protection film 84 as a two-layer constitution, a two-layer constitution, a four-layer constitution, and a two-layer constitution, respectively.

As shown in FIG. 4, each carrier 25 has a support base 26 and a plurality of substrate attachment units 27 (two substrate attachment units in this embodiment) provided on an upper surface of the support base 26.

The substrate attachment units 27 is configured so that a circular through-hole 29 slightly larger in diameter than an outer circumference of the film-formation substrates 23 and 24 is formed in a plate 28 having substantially equal thickness to the film-formation substrates (nonmagnetic substrates) 23 and 24. A plurality of support members 30 protruding toward inside of the through-hole 29 is provided around the through-hole 29. In this substrate attachment unit 27, the film-formation substrate 23 and 24 is fitted into the through-hole 29 and the support members 30 are engaged with an edge of the film-formation substrate 23 and 24, thereby holding the film-formation substrate 23 and 24. The substrate attachment units 27 are provided on the upper surface of the support base 26 in parallel so that principal surfaces of the two attached film-formation substrates 23 and 24 are substantially orthogonal to the upper surface of the support base 26 and are substantially flush with each other. Hereafter, the two film-formation substrates 23 and 24 attached to these substrate attachment units 27 are referred to as first film-formation substrate 23 and second film-formation substrate 24, respectively.

The substrate cassette transfer robot 3 supplies the substrates to the substrate supply robot chamber 2 or the substrate attachment chamber 52 from the cassette placed in the film-formation substrates 23 and 24 and takes out magnetic disks detached in the substrate detachment robot chamber 22 or 53 (the film-formation substrates of which the respective thin films 81 to 84 are formed). An aperture opening externally and doors 51 and 55 opening/closing the aperture are provided on one sidewall of each of the substrate supply robot chamber 2 and the substrate detachment robot 22.

Further, each of the chambers 2, 52, 4 to 20, 54, and 3A is connected to two adjacent walls and gate valves 52-72 are provided in connection units of each of these chambers. When these gate valves 52-72 are closed, an interior of each chamber becomes an independent closed space.

Each of the corner chambers 4, 7, 14, and 17 is a chamber for changing a moving direction of each carrier 25 and a mechanism rotating the carrier and moving the carrier to a next chamber is provided within each chamber.

The protection film formation chambers 18 to 20 is a chamber for forming a protection film on a surface of an uppermost layer formed on the first film-formation substrate 23 and the second film-formation substrate 24 by the CVD method or the like. A reactive gas supply pipe and a vacuum pump, not shown, are connected to each of the protection film formation chambers 18 to 20.

A valve controlled to be open or closed by a control mechanism, not shown, is provided on the reactive gas supply pipe, and a pump gate valve controlled to be open or closed by control means, not shown, is provided between the vacuum pump and each of the protection film formation chambers 18 to 20. By manipulating the valve provided on the reactive gas supply pipe and the pump gate valves to be open or closed, supply of gas from a sputtering gas supply pipe, internal pressure of protection film formation chamber, and emission of gas are controlled.

In case of film formation by the CVD method in the protection film formation chambers, if reactive gas is supplied into the chamber and high frequency voltage is applied between an electrode and film-formation substrate, discharge occurs therebetween and the reactive gas introduced into the chamber is turned into a plasma state by this discharge. A protection film is formed by adhesion of reactants of active radicals or ions generated in this plasma onto the surface of the uppermost layer formed on the film-formation substrates 23 and 24.

In the substrate detachment chamber 54, the first film-formation substrate 23 and the second film-formation substrate 24 attached to the carrier 25 are detached by using the robot 49. Thereafter, the carrier 25 is transported into the carrier ashing chamber 3A.

First, in the ashing treatment performed on the carbon film deposited on the carrier according to the embodiment, the substrates on which the magnetic film and the protection film are formed are detached from the substrate-holding carrier in vacuum. Thereafter, only the carrier on which the carbon film is deposited as well as the substrates are installed in the chamber, oxygen gas is simultaneously introduced from any portions of the chamber, and oxygen plasma is generated in the chamber by using this oxygen gas. If the generated oxygen plasma contacts with the carbon film deposited on the surface of the carrier, the oxygen plasma decomposes carbon to CO or CO₂ gas and removes the carbon.

In this case, it is known that the generated plasma tends to concentrate on sharp portions or neighborhoods of an introduction portion of a plasma generation power because of property of the plasma, when ashing treatment is performed on carbon film. As a result, ends of the carrier and the neighborhoods of the introduction portion of the plasma generation power of the carrier are positively subjected to the ashing treatment while it is difficult to uniformly perform ashing treatment on the entire carrier including flat portions.

According to the present invention, to solve this problem, a bias voltage is applied to the carrier as a purpose, so that the plasma can uniformly converge into the carrier. By applying the bias voltage to the carrier, the plasma can uniformly converge into the carrier and the carbon film deposited on the surface of the carrier can be efficiently and uniformly removed.

Furthermore, according to the present invention, pulse-shaped bias voltage (pulsed bias voltage) is preferably used as the bias voltage applied to the carrier. The reason for using the pulsed bias voltage is to prevent generation of arcing during application of the bias voltage. Namely, if the bias voltage is applied to the carrier, then an electrode rod provided in the chamber is pressed against the carrier, and the voltage is applied to the carrier through this electrode rod. At this time, arching occurs in a portion in which the electrode rod is pressed against the carrier. However, if the pulsed bias voltage is used for the carrier, this arcing can be reduced.

The pulsed voltage bias used in the present invention has a pulse width in a range of 400 n seconds to 5000 n seconds or preferably in a range of 500 n seconds to 1000 n seconds, a pulse cycle in a range of 5 kHz to 350 kHz or preferably in a range of 100 kHz to 200 kHz, and a voltage in a range of 100 V to 400 V or preferably in a range of 200 V to 300 V. By using the pulsed voltage bias in these ranges, the carrier can efficiently perform plasma asking of the carrier.

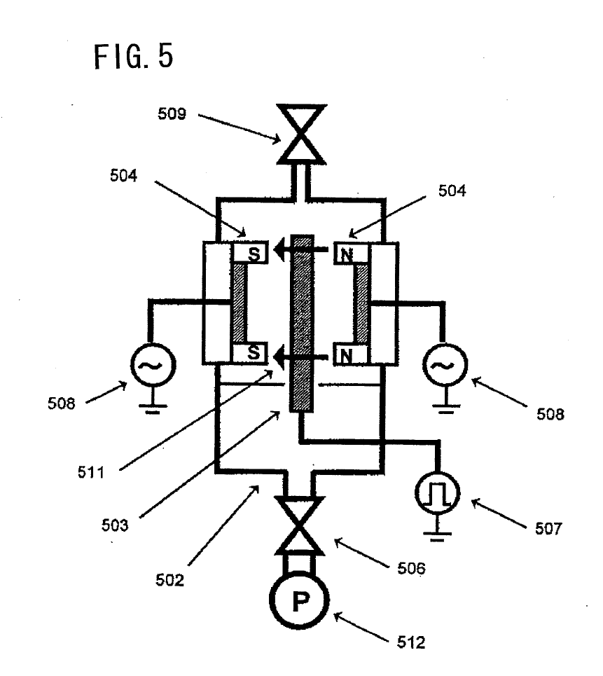

Moreover, according to the present invention, a magnetic field is used for performing plasma flow control as a purpose of uniform convergence of the plasma into the carrier. As a procedure of forming the magnetic field, installation of a fixed permanent magnet or electromagnet either inside or outside of the chamber may be considered and a configuration of the magnetic field shown as in FIG. 5 may be considered. Particularly if fixed permanent magnets 504 are used, then the configuration of the device can be made simpler and it is possible to easily allow the plasma to converge to correspond to the position of a carrier 503 at which ashing is to be performed.

Furthermore, a rotating magnetic field can be applied to the plasma. This rotating magnetic field enables kinetic energy to be applied to the plasma contributing to the ashing treatment and oxygen radicals to be incident from oblique direction while the oxygen radicals are drawing a spiral orbit with respect to the carrier.

The oxygen plasma in contact with the carbon on the surface of the carrier reacts with the carbon, transforms the carbon into CO or CO₂, and contributes to an action of removing the carbon from the surface of the carrier in the form of emission into the chamber.

According to the present invention, pure oxygen gas is basically used when the above-stated treatment is performed. It is preferable to use mixture gas of inactive gas such as argon (Ar) gas and oxygen gas as treatment gas. While the oxygen gas has high carbon removal effect, the oxygen gas is difficult to ionize and it is difficult to generate plasma as compared with the inactive gas. Therefore, addition of the inactive gas to the oxygen gas facilitates generating plasma and stable plasma can be obtained.

The mixture gas may be obtained by independently introducing to respective gases into the chamber and mixing up the gases in the chamber and supplied or may be obtained by mixing up the gases in a pipe and supplying them into the chamber.

Moreover, according to the present invention, it is preferable that a concentration of the inactive gas in the gas is increased as compared with that of the oxygen gas at an initial stage of plasma formation, thereby stabilizing generation of the plasma, and that the concentration of the oxygen gas is then increased to improve carbon removal efficiency.

Further, after removal of the carbon by the ashing treatment, the concentration of the inactive gas is increased again, thereby generating inactive gas plasma to make it possible to remove a film of a metal component deposited on the surface of the carrier by physical etching.

Next, as for an internal pressure of the chamber during the treatment, the treatment can be performed with the internal pressure falling in a range of 0.5 Pa to 10 Pa. Conventionally, if the carrier is subjected to ashing using oxygen plasma, the internal pressure of the chamber for generating the oxygen plasma is limited to 2 Pa on a reduced pressure side. According to the present invention, the magnetic field is applied to neighborhoods of the carrier to concentrate the plasma on the neighborhoods of the carrier. It is, therefore, possible to stabilize generation of the plasma and generate oxygen plasma at pressure lower than 2 Pa. It is thereby possible to perform ashing on the carrier at low gas pressure and emit residual gas in the chamber in short time after the end of discharge.

According to the present invention, if the internal pressure of the chamber is too low during the ashing treatment, discharge of the oxygen plasma is made unstable. If the internal pressure of the chamber is too high, it takes longer time to emit the residual oxygen gas in the chamber after the end of discharge. Preferably, therefore, the gas pressure is set in a range of 0.5 Pa to 5 Pa. A flow rate of the treatment gas is preferably in a range of 100 sccm to 500 sccm while the pressure satisfies the above-stated range. A exhaust volume regulation valve 506 installed in the chamber is used corresponding to regulate the pressure.

According to the present invention, the oxygen plasma is generated in the chamber. High frequency power applied into the chamber at the time of generation of the oxygen plasma is the high frequency power of frequency in a range from 13.56 MHz to 60 MHz or preferably 13.56 MHz in light of easy handling or specifications required for facilities. It is also preferable that the high frequency power introduced into the chamber is in a range from 100 W to 500 W. Furthermore, since the carrier itself is heated to follow application of the high frequency power, treatment time per one ashing treatment is desired within ten seconds and more preferably within three seconds in light of productivity.

In the inline film formation device, a next new substrate before film formation is supplied to the carrier completed with an ashing step. Subsequently, in another chamber, films of materials necessary to constitute the magnetic recording medium are sequentially formed or a treatment of heating the substrate is subjected. At this time, in the former, when the films of the necessary materials are formed by magnetron discharge, outgas emitted into the chamber deteriorates purity of process gas (normally pure Ar) necessary for discharge and, therefore, causes degradation in qualities of the films itself to be formed. Further, in the latter case of heating the substrate, the carrier itself is also heated together with the substrate, thereby promoting emission of outgas CO or CO₂ from the surface of the carrier. The out gas emitted from the carrier adheres onto the surface of the substrate before film formation, thereby causing deteriorations in magnetostatic characteristics or electromagnetic conversion characteristics of the magnetic recording medium. According to the present invention, it is possible to minimize these influences.

A device shown in FIG. 5 is an example of a device performing ashing on the carrier according to the present invention. This device is for performing ashing on the carrier and a chamber 502 stores therein the substrate-holding carrier 503 in a vacuum state. At this time, no substrate is installed on the carrier 503. The magnets 504 for formation of a magnetic field are installed within the chamber. In the chamber 9, a magnetic field 511 from the magnets 504 is generated in the chamber 502 and plasma converges into three portion of the carrier 503. An exhaust port is provided in the chamber 502 and gas within the chamber 502 is absorbed and removed by a exhaust pump 512. A exhaust volume regulation valve 506 can arbitrary set the volume of the exhaust. High frequency power is applied into the chamber 502 from a high frequency power supply 508. A gas introduction pipe 509 is installed in the chamber 502, thereby introducing the treatment gas into the chamber 502.

The power supply 508 supplies power for generating plasma in the oxygen-containing gas during the carrier ashing according to the embodiment. As the power supply 508, a high frequency power supply and a microwave power supply can be used. A capacity of the power supply 508 is preferably set so as to be able to supply the power of 50 W to 100 W into the chamber during ashing discharge.

The gas introduced into the chamber is preferably gas mainly consisting of oxygen as main component during the ashing treatment. In this case, mixture gas of inactive gas such as argon gas and oxygen gas can be used. However, since the argon gas gives no contribution to decomposing and removing the carbon deposited film in the form of CO or CO₂, pure oxygen gas is preferably used during the ashing treatment. Furthermore, it is not preferable to use gas other than the argon gas or the oxygen gas, for example, nitrogen gas or the like since the gas adheres to the carrier to reduce degree of vacuum of the chamber. From these resects, the oxygen gas used for the ashing treatment is preferably high purity oxygen gas at purity of 99.9% or more.

The ashing treatment according to the embodiment starts at closing the gate valve of the chamber after storing the carrier 503 in a state in which no substrate is installed in the chamber 502 kept in a vacuum state at least equal to or lower than 1×10⁻⁴ Pa. Thereafter, the oxygen gas is introduced from the gas introduction pipe 509, the volume of the exhaust is appropriately regulated by the exhaust volume regulation valve 506 to keep the internal pressure of the chamber in the range of 2 Pa to 5 Pa, and then the high frequency power is applied to the carrier 503 from the power supply 508. The frequency of the high frequency power to be applied is preferably 13.56 MHz in view of practicality. Furthermore, in the range of the high frequency power of 100 W to 1000 W, considering the ashing amount per unit time and the temperature rise of the carrier itself due to the application of the high frequency power, it is preferable to complete the treatment within time of about two to five seconds to corresponds with more practical industrial production in the range of 300 W to 500 W. The oxygen gas introduced into the chamber is ionized and decomposed into oxygen plasma by the high frequency power applied to the chamber 502. At this time, the plasma mainly concentrates on the introduction portion of the high frequency power and the sharp portions of the carrier or the like, while the flat portions of the carrier are insufficiently subject to the ashing treatment. Therefore, a bias voltage or preferably pulsed bias voltage 507 is applied to the carrier and the magnets 504 are used for convergence of the plasma. The oxygen plasma in contact with the carbon on the surface of the carrier reacts with the carbon, transforms the carbon into CO or CO₂, and contributes to the action of removing the carbon from the surface of the holder in the form of emission into the chamber.

The generated oxygen plasma reacts with the carbon film deposited on the surface of the carrier to transform the carbon into CO or CO₂. The completely gaseous CO or CO₂ is emitted from the outside of the chamber by the exhaust pump 512, thereby removing the carbon on the surface of the carrier. In this case, when the ashing treatment is finished, supply of the oxygen gas from the gas introduction pipe 509 is stopped, and the residual oxygen gas is also emitted outside of the chamber by the exhaust pump 512. Thereafter, the gate valve provided in the chamber is opened and the carrier starts moving from the chamber 502. It is unpreferable to open the gate valve before the CO or CO₂ gas generated by the ashing treatment within the chamber 502 and further the oxygen gas are sufficiently evacuated from the chamber 502 since the gases flow into the next chamber. Desirably, therefore, the exhaust volume regulation valve 506 operates instantly at the stage of completion of the ashing treatment to reach a maximum exhaust rate. The exhaust volume regulation valve preferably completely finishes operating within 1.5 seconds or less or ideally within 0.5 seconds or less to be able to contribute to emission of the residual gas within the chamber, depending on a production rate of the overall sputtering device. The exhaust rate of the exhaust pump 512 is desired at least equal to or higher than 1000 liters per second or more preferably equal to or higher than 2000 liters per second, depending on chamber size.

### EXAMPLES

Examples of the carrier ashing according to the present invention will be described hereinafter. However, the present invention is not limited only to these examples.

### Examples 1 to 26 (Ex.1-Ex.26)

After a nonmagnetic substrate constituted by a NiP-plated aluminum substrate was supplied into the chamber of the sputtering film formation device by using a substrate transport machine, the chamber was exhausted. After completion of exhausting, the substrate was attached to a carrier made of A5052 aluminum alloy by using substrate transport machine in a vacuum environment of the chamber. A sandblasting treatment was subjected on the surface of the carrier by using SiC particles of #20 to #30. After forming the film of the base layer made of Cr and the magnetic recording layer made of Co necessary to constitute the magnetic recording medium were formed on the substrate attached to the carrier in the sputtering chamber, the carbon protection film of 50 Å was formed on the substrate by the plasma CVD in the CVD chamber. At this time, carbon was also deposited on the surface of the carrier near the substrate.

Thereafter, the substrate was detached from the carrier by the substrate transport machine in the chamber. The carrier from which the substrate was detached was transported into the next chamber. Subsequent treatments will be described with reference to FIG. 5. The oxygen gas and the argon gas were supplied from the gas introduction pipe 509 shown in FIG. 5 and the exhaust volume regulation valve was appropriately manipulated, thereby regulating the internal pressure of the chamber in the range of 0.5 Pa to 5.6 Pa. Thereafter, high frequency power at 13.56 MHz was applied in a total range of 200 W to 1000 W to two cathodes provided in the chamber. At this time, the magnets 504 were attached to or detached from neighborhoods of the substrate installation position of the carrier. The treatment time using the plasma was set to 1 second to 2.8 seconds. Table 1 shows treatment conditions and deposited carbon film removal rates according to the examples 1 to 26 (Ex.1-Ex.26). It is to be noted that the deposited carbon film removal rates were evaluated by measuring of the carbon film thickness before and after the ashing treatment. Furthermore, only the argon gas was supplied for first 0.3 second since generation of plasma and then the mixture gas of argon and oxygen described in the Table 1 was supplied, and only the argon gas was supplied for the last 0.3 second.

### Comparative Examples 1 to 8 (C1-C8)

Similarly to the examples, the carrier was performed to ashing treatment. However, in the comparative examples 1 to 8, the bias voltage was not applied to the carrier but the high frequency power was applied to the carrier to generate the plasma around the carrier and perform carbon ashing. The Table 2 shows ashing conditions and carbon removal rates according to the comparative examples 1 to 8 (C1-C8).

### Comparative Examples 9 to 15 (C9-C15)

Similarly to the examples, the carrier was performed to the ashing treatment. However, in the comparative examples 9 to 15, the carbon ashing was performed without applying the bias voltage to the carrier. The Table 2 shows ashing conditions and carbon removal rates according to the comparative examples 9 to 15 (C9-C15).

### INDUSTRIAL APPLICABILITY

The method of manufacturing the magnetic recording medium according to the present invention can effectively reduce the carbon film deposited on the substrate-holding carrier, suppress generation of particles to follow peeling off the deposited film, and suppress emission of outgas originating from the carbon film deposited on the surface of the carrier when the carbon protection film is formed on the substrate by the CVD method or the like. Therefore, it is possible to provide a magnetic recording medium high in recording density, excellent in recording and reproducing characteristics, and stable in quality.

TABLE 1

| | High | Applica- | Oxygen | Argon | | | | Carrier bias | | | Carrier | Carbon |
|---|---|---|---|---|---|---|---|---|---|---|---|---|
| Examples | frequency | tion of | supply | supply | Treatment | Chamber | Cathode | | | Pulse | high | removal |
| (Ex. 1-Ex. | application | magnetic | amount | amount | time | pressure | frequency | Voltage | Pulse width | cycle | frequency | rates |
| 26) | position | field | [sccm] | [sccm] | [seconds] | [Pa] | power [W] | [V] | [n seconds] | [kHz] | power [W] | [%] |
| Ex. 1 | Cathode | NO | 500 | 20 | 2.0 | 10.0 | 1000 | 200 | Stationary voltage | — | — | 95.4 |
| Ex. 2 | Cathode | NO | 210 | 20 | 2.0 | 5.0 | 1000 | 200 | Stationary voltage | — | — | 94.4 |
| Ex. 3 | Cathode | NO | 500 | 20 | 2.0 | 1.7 | 1000 | 200 | Stationary voltage | — | — | 95.5 |
| Ex. 4 | Cathode | NO | 500 | 20 | 2.0 | 1.7 | 250 | 200 | Stationary voltage | — | — | 75.7 |
| Ex. 5 | Cathode | NO | 500 | 20 | 2.0 | 1.7 | 500 | 200 | Stationary voltage | — | — | 88.1 |
| Ex. 6 | Cathode | NO | 500 | 20 | 2.0 | 1.7 | 750 | 200 | Stationary voltage | — | — | 93.9 |
| Ex. 7 | Cathode | NO | 500 | 20 | 2.0 | 1.7 | 500 | 200 | Stationary voltage | — | — | 69.5 |
| Ex. 8 | Cathode | NO | 500 | 20 | 2.0 | 1.7 | 500 | 100 | Stationary voltage | — | — | 77.5 |
| Ex. 9 | Cathode | NO | 500 | 20 | 2.0 | 1.7 | 500 | 300 | Stationary voltage | — | — | 92.7 |
| Ex. 10 | Cathode | NO | 500 | 20 | 2.0 | 10.0 | 500 | 200 | Stationary voltage | — | — | 93.7 |
| Ex. 11 | Cathode | NO | 500 | 20 | 2.0 | 1.7 | 500 | 200 | Stationary voltage | — | — | 87.7 |
| Ex. 12 | Cathode | NO | 310 | 20 | 2.0 | 1.0 | 500 | 200 | Stationary voltage | — | — | 82.0 |
| Ex. 13 | Cathode | YES | 500 | 20 | 1.5 | 10.0 | 500 | 200 | Stationary voltage | — | — | 94.8 |
| Ex. 14 | Cathode | YES | 500 | 20 | 1.5 | 1.7 | 500 | 200 | Stationary voltage | — | — | 95.7 |
| Ex. 15 | Cathode | YES | 310 | 20 | 1.5 | 1.0 | 500 | 200 | Stationary voltage | — | — | 95.3 |
| Ex. 16 | Cathode | YES | 150 | 20 | 1.5 | 0.5 | 500 | 200 | Stationary voltage | — | — | 95.8 |
| Ex. 17 | Cathode | YES | 150 | 20 | 1.5 | 0.5 | 200 | 200 | Stationary voltage | — | — | 94.7 |
| Ex. 18 | Cathode | YES | 150 | 20 | 1.5 | 0.5 | 300 | 200 | Stationary voltage | — | — | 95.5 |
| Ex. 19 | Cathode | YES | 150 | 20 | 1.5 | 0.5 | 400 | 200 | Stationary voltage | — | — | 95.6 |
| Ex. 20 | Cathode | YES | 310 | 20 | 1.5 | 1.0 | 200 | 200 | Stationary voltage | — | — | 95.8 |
| Ex. 21 | Cathode | YES | 310 | 20 | 1.5 | 1.0 | 300 | 200 | Stationary voltage | — | — | 95.7 |
| Ex. 22 | Cathode | YES | 310 | 20 | 1.5 | 1.0 | 400 | 200 | Stationary voltage | — | — | 95.6 |
| Ex. 23 | Cathode | YES | 150 | 20 | 1.5 | 0.5 | 300 | 200 | Stationary voltage | — | — | 84.1 |
| Ex. 24 | Cathode | YES | 150 | 20 | 1.5 | 0.5 | 300 | 200 | 500 | 100 | — | 95.1 |
| Ex. 25 | Cathode | YES | 150 | 20 | 1.5 | 0.5 | 300 | 200 | 500 | 150 | — | 95.8 |
| Ex. 26 | Cathode | YES | 150 | 20 | 1.5 | 0.5 | 300 | 200 | 500 | 200 | — | 95.6 |

TABLE 2

| | High | Application | Oxygen | Argon | | | Cathode | Carrier bias | | | Carrier | Carbon |
|---|---|---|---|---|---|---|---|---|---|---|---|---|
| Comparative | frequency | of | supply | supply | Treatment | Chamber | high | | | Pulse | high | removal |
| Examples | application | magnetic | amount | amount | time | pressure | frequency | Voltage | Pulse width | cycle | frequency | rates |
| (C1-C15) | position | field | [sccm] | [sccm] | [seconds] | [Pa] | power [W] | [V] | [n seconds] | [kHz] | power [W] | [%] |
| C1 | Carrier | NO | 500 | 20 | 2.8 | 5.6 | — | — | — | — | 200 | 18.8 |
| C2 | Carrier | NO | 500 | 20 | 2.8 | 5.6 | — | — | — | — | 300 | 26.6 |
| C3 | Carrier | NO | 500 | 20 | 2.8 | 5.6 | — | — | — | — | 400 | 39.0 |
| C4 | Carrier | NO | 500 | 20 | 2.8 | 5.6 | — | — | — | — | 500 | 54.4 |
| C5 | Carrier | NO | 500 | 20 | 2.8 | 5.6 | — | — | — | — | 300 | 28.6 |
| C6 | Carrier | NO | 400 | 20 | 2.8 | 5.6 | — | — | — | — | 300 | 28.8 |
| C7 | Carrier | NO | 300 | 20 | 2.8 | 5.6 | — | — | — | — | 300 | 29.5 |
| C8 | Carrier | NO | 200 | 20 | 2.8 | 5.6 | — | — | — | — | 300 | 25.3 |
| C9 | Cathode | YES | 500 | 20 | 2.0 | 1.7 | 500 | 0 | — | — | — | 61.8 |
| C10 | Cathode | YES | 150 | 20 | 1.5 | 0.5 | 200 | 0 | — | — | — | 70.2 |
| C11 | Cathode | YES | 150 | 20 | 1.5 | 0.5 | 300 | 0 | — | — | — | 73.3 |
| C12 | Cathode | YES | 150 | 20 | 1.5 | 0.5 | 400 | 0 | — | — | — | 74.1 |
| C13 | Cathode | YES | 310 | 20 | 1.5 | 1.0 | 200 | 0 | — | — | — | 69.9 |
| C14 | Cathode | YES | 310 | 20 | 1.5 | 1.0 | 300 | 0 | — | — | — | 71.3 |
| C15 | Cathode | YES | 310 | 20 | 1.5 | 1.0 | 400 | 0 | — | — | — | 73.9 |

1. A method of manufacturing a magnetic recording medium which comprises steps of:
sequentially transporting a film-formation substrate attached to a carrier into a plurality of chambers connected to one another;
forming at least a magnetic film and a carbon protection film on said film-formation substrate;
detaching the magnetic recording medium after film formation from said carrier;
subjecting the carbon film deposited and adhering onto a surface of the carrier to an ashing removal in oxygen-containing plasma generated in a chamber;
attaching a next film-formation substrate to the carrier; and
wherein a bias voltage is applied to the carrier when executing the step of subjecting the carbon film to the ashing removal.

2. The method of manufacturing the magnetic recording medium according to claim 1, wherein the bias voltage is a pulsed voltage bias.

3. The method of manufacturing the magnetic recording medium according to claim 1, wherein inactive gas is further added to the plasma.

4. The method of manufacturing the magnetic recording medium according to claim 3, wherein at an initial stage of the step of subjecting the carbon film to the ashing removal, a concentration of the inactive gas in the plasma is increased as compared with an oxygen gas concentration and the oxygen gas concentration is then increased as compared with the concentration of the inactive gas.

5. The method of manufacturing the magnetic recording medium according to claim 4, wherein after the oxygen gas concentration is increased as compared with the concentration of the inactive gas, the concentration of the inactive gas is increased again as compared with the oxygen gas concentration.

6. The method of manufacturing the magnetic recording medium according to claim 1, wherein a magnetic field is applied to the oxygen-containing plasma from an outside to concentrate the plasma acting on the ashing removal on the surface of the carrier.

7. The method of manufacturing the magnetic recording medium according to claim 6, wherein the magnetic field applied to the plasma is a magnetic field generated by a permanent magnet.

8. The method of manufacturing the magnetic recording medium according to claim 2, wherein a magnetic field is applied to the oxygen-containing plasma from an outside to concentrate the plasma acting on the ashing removal on the surface of the carrier.

9. The method of manufacturing the magnetic recording medium according to claim 3, wherein a magnetic field is applied to the oxygen-containing plasma from an outside to concentrate the plasma acting on the ashing removal on the surface of the carrier.

10. The method of manufacturing the magnetic recording medium according to claim 4, wherein a magnetic field is applied to the oxygen-containing plasma from an outside to concentrate the plasma acting on the ashing removal on the surface of the carrier.

11. The method of manufacturing the magnetic recording medium according to claim 5, wherein a magnetic field is applied to the oxygen-containing plasma from an outside to concentrate the plasma acting on the ashing removal on the surface of the carrier.
